(19) United States
(12) Patent Application Publication
(10) Pub. No.: US 2026/0022229 A1
(43) Pub. Date: Jan. 22, 2026

(54) THERMALLY CONDUCTIVE PLASTIC

(71) Applicant: Wacker Chemie AG, Munich (DE)

(72) Inventor: Sebastian Knoer, Emmerting (DE)

(73) Assignee: Wacker Chemie AG, Munich (DE)

(21) Appl. No.: 18/995,328

(22) PCT Filed: Jul. 21, 2022
(86) PCT No.: PCT/EP2022/070526

§ 371 Date: Jan. 16, 2025

(51) Int. Cl. C08K 3/34

(52) U.S. Cl. CPC C08K 3/34; C08K 2201/001

(57) ABSTRACT

Thermally conductive plastic compositions, methods of producing and uses for the same. Where the thermally conductive plastics composition (Y) includes 5-50% by volume of a non-silicone-based plastics composition(S), 50-95% by volume of at least one thermally conductive filler (Z) having a thermal conductivity of at least 5 W/mK and the thermally conductive plastics composition (Y) has a thermal conductivity of at least 0.6 W/mK. At least 20% by volume of the metallic silicon particles are present as thermally conductive fillers (Z) that: (i) average diameter x50 is in the range 30-200 μm, (ii) are predominantly rounded and characterized in that the width/length ratio (aspect ratio w/l) is at least 0.76, and (iii) are distribution width SPAN ((x90−x10)/x50) is at least 0.28.

The present invention relates to a thermally conductive plastic, to the production thereof and to the use thereof.

### Prior Art

Thermally conductive plastics are widely used in thermal management in the automotive and electronics industries. Important usage forms comprise for example thermally conductive adhesives, thermally conductive pads, gap filler, potting compounds and pastes.

Plastics typically exhibit a low thermal conductivity. Typical thermal conductivities of plastics are in the range from about 0.2 to 0.3 W/mK.

The prior art discloses various thermally conductive fillers which are added to increase the thermal conductivity of plastics. However, these have severe disadvantages. Ceramic fillers, such as for example aluminum oxide, have a very high density and thus very markedly increase the weight of the components. They are also relatively costly. Metallic fillers, for example aluminum powder or silver powder, are electrically conductive which is unacceptable for many applications. Many metals and alloys are also relatively costly.

Many further, highly thermally conductive fillers, for example carbon nanotubes, boron nitride and aluminum nitride, may, on account of their relatively high cost, only be employed to a limited extent, in small amounts or in specific applications.

The prior art discloses various thermally conductive plastics compositions which contain silicon particles as thermally conductive filler. These are relatively light and cost-effective. Silicon, as a semiconductor, also has an extremely low electrical conductivity. However, the silicon particles of the prior art are not suitable for use in electric vehicles and electronic components.

The Si particles are usually obtained by milling processes. The disadvantage of this is that such particles have a large surface area and bind a great deal of polymer. This very markedly increases the viscosity of the plastics composition. Only mixtures with relatively low filler contents and low thermal conductivity can be produced. At higher filler contents the composition becomes very stiff and can no longer be dispensed using classical processes, for example a dispenser. Plastics compositions containing ground silicon particles have also proven to be relatively flammable.

The use of silicon particles smaller than 30 μm is disadvantageous since such small particle have a relatively low minimum ignition energy and thus pose a dust explosion hazard and require complex and costly safety precautions in the course of industrial processing.

JP2019131669A2 teaches the use of 0.1-200 μm metallic Si particles having an electrically insulating coating as thermally conductive fillers for silicone-free organic resins. The particles may be produced by thermal decomposition, melting or milling processes or from polishing or grinding processes. The particles are provided with an electrically insulating coating in a separate process step. In its examples JP2019131669A2 discloses organic radicals which comprise up to 65% by volume of milled Si particles having an average particle size of 32 μm and a thermal conductivity of up to 7 W/mK aufweisen. The use of comparatively flammable milled particles is disadvantageous. The disclosed vulcanizates are not elastic and thus not suitable for use as gap filler in lithium-ion batteries.

CN106753140A claims epoxy resins containing two fractions of spherical silicon particles of 20 and 27 μm in size.

JP2013221124A21 claims polyarylene sulfide resins containing silicon particles larger than 1μm and of any desired shape and mode of manufacture. The example employs irregularly shaped silicon particles of 6 and 17 μm in size.

US2015307764A (=EP2935432A1) claims plastics compositions which may contain metallic silicon particles. The preferred size range is 1 to 50 μm. The shape is is not specified further. The example employs silicon particles of 2.5 μm in size.

Silicones are undesired in many applications since these can liberate volatile polydimethylsiloxanes which can impair the adhesion of components or coatings.

It is accordingly an object of the present invention to provide non-silicone-based and thus polydimethylsiloxane-free plastics compositions which do not exhibit the abovementioned disadvantages of the prior art and combine the properties of low density, low cost and high thermal conductivity.

This object is achieved by the thermally conductive plastics compositions (Y) according to the invention which contain relatively large Si particles having an average particle size of 30 to 200 μm and a predominantly rounded shape and which simultaneously and which simultaneously exhibit a particularly large/broad particle size distribution. It has very surprisingly now been found by experiment that these thermally conductive plastics compositions (Y) according to the invention exhibit a markedly reduced flammability.

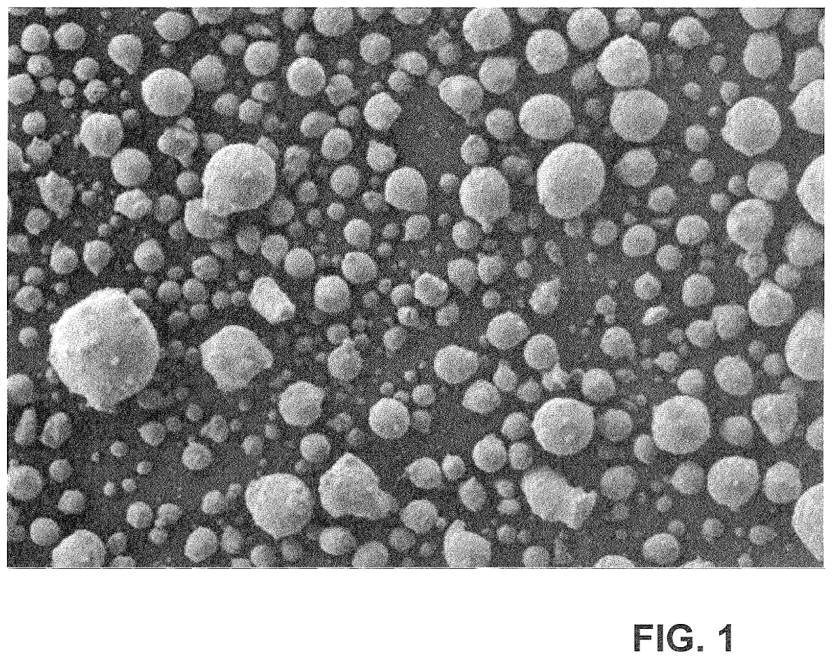

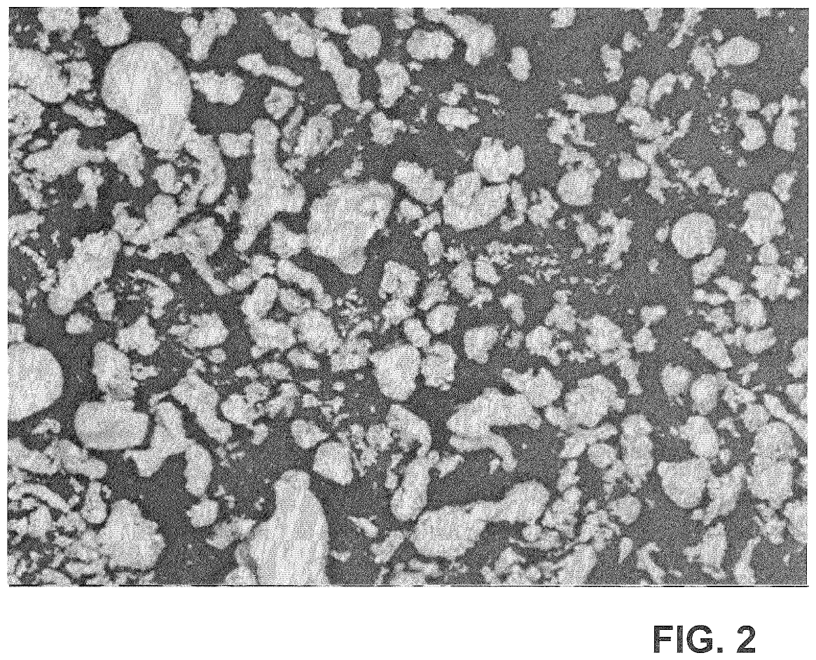

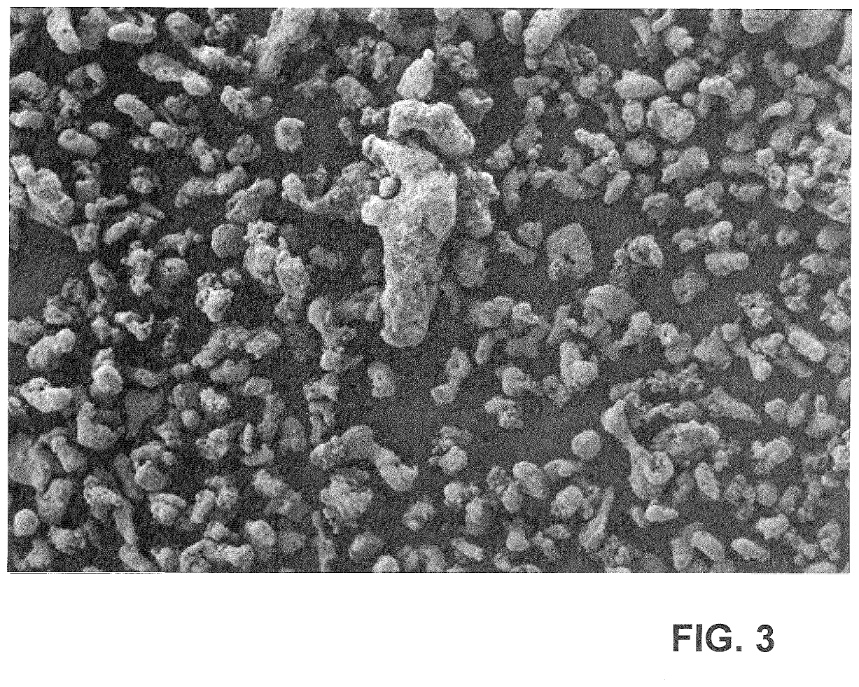

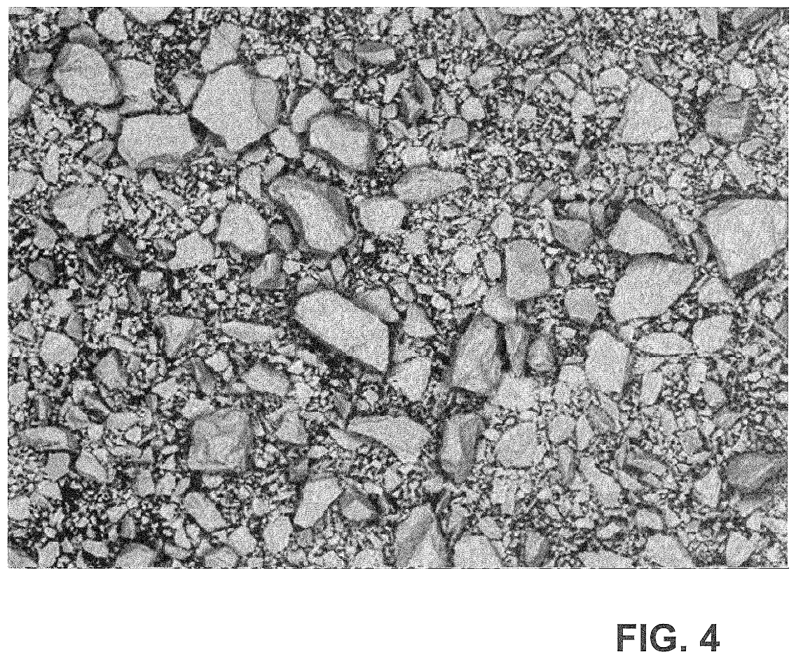

In the context of the present invention “predominantly rounded” Si particles are to be understood as meaning those having a spherical to oval shape with smooth surfaces. They could also be described as potato-shaped. FIG. 1 shows the inventive predominantly rounded shape of these Si particles by way of example. The inventive Si particles have a width/length ratio (aspect ratio w/l) of at least 0.76 Noninventive Si particle shapes whose with/length ratio (aspect ratio w/l) is smaller than 0.76 are shown in FIG. 2 with “spattered particles”, in FIG. 3 with “nodular” particles and in FIG. 4 with “sharp-edged” and “pointed” particles. A person skilled in the art is aware that there is broad overlap between the different particle shapes. Inventive metallic Si particles have a width/length ratio (aspect ratio w/l) of at least 0.76 and are preferably substantially neither sharp-edged nor pointed, preferably neither spattered nor nodular nor sharp-edged nor pointed. However, this is to be understood as meaning that said inventive particles may contain such particles in the context of an impurity without disrupting their inventive effect.

The properties of the Si particles according to FIGS. 1 to 4 are also reproduced in the following table.

| Figure | X50 (μm) | w/l | SPHT | |
|---|---|---|---|---|
| 1 | 98 | 0.84 | 0.87 | inventive |
| 2 | 38 | 0.68 | 0.70 | noninventive |
| 3 | 73 | 0.67 | 0.72 | noninventive |
| 4 | 37 | 0.67 | 0.76 | noninventive |

The present invention provides a thermally conductive plastics composition (Y) containing
5-50% by volume of a plastics composition (S) and
50-95% by volume of at least one thermally conductive filler (Z) having a thermal conductivity of at least 5 W/mK, with the proviso that
the thermally conductive plastics composition (Y) has a thermal conductivity of at least 0.6 W/mK and that
at least 20% by volume of metallic silicon particles fulfilling the following features are present as thermally conductive fillers (Z):
   a) their average diameter x50 is in the range 30-200 μm;
   b) they are predominantly rounded and characterized in that the width/length ratio (aspect ratio w/l) is at least 0.76;
   c) their distribution width SPAN ((x90−x10)/x50) is at least 0.28.

The plastics compositions according to the invention preferably also fulfill feature d) and contain not more than 1.5% by weight of silicon particles smaller than 2 μm.

In the context of the present invention the terms heat-conducting, thermoconductive or thermally conductive are synonymous.

In the context of the present invention the term “thermally conductive fillers (Z)” is to be understood as meaning fillers having a thermal conductivity of at least 5 W/mK.

In the context of the present invention the term “thermally conductive plastics composition (Y)” is to be understood as meaning plastics compositions which markedly exceed the thermal conductivity of a filler-and additive-free plastic, typically about 0.2 to 0.3 W/mK, characterized in that they have a thermal conductivity of at least 0.6 W/mK.

In the context of the present invention all parameters describing particle size (parameter: average diameter x50), particle size distribution (parameter: standard deviation Sigma and distribution width SPAN) or particle shape (parameter: aspect ratio w/l and sphericity SPHT) relate to a volume-based distribution. The indices mentioned may be determined, for example, by dynamic image analysis according to ISO 13322-2 and ISO 9276-6, for example with a Camsizer X2 instrument from Retsch Technology.

A person skilled in the art is aware that the standard deviation is not normalized and is only a useful characteristic for evaluating the particle size distribution of different samples if the average particle sizes of the comparative samples are approximately equal. Therefore, in the context of the present invention, the relative width of the particle size distribution is described using the average particle size x50-weighted width of the particle size distribution, the dimensionless distribution width SPAN which is defined as:

$$SPAN = ( x 90 - x 10 ) / x 50.$$

The aspect ratio is used as an index for describing the particle shape. The older prior art often describes the aspect ratio via the ratio of the length to width (l/w). This gives values of not less than 1. In the newer literature, for example according to ISO 9276-6, the aspect ratio is calculated inverse ratio of width to length (w/l). This gives values of not more than 1. The two indices may be interconverted by forming the reciprocal. In the context of the present invention the aspect ratio is defined as the ratio of the width to the length (w/l) of the particle. Particle width is defined as x_{c min}, the smallest of all measured maximum chords of the particle projection and particle width is defined as x_{Fe max}, the longest Feret diameter of all measured Feret diameters of a particle. More detailed information may be found for example in “Operating Instructions/Manual Particle Size analysis System CAMSIZER®”, Retsch Technology GmbH, 42781 Haan; Doc. No. CAMSIZER V0115. This gives the following formula for the aspect ratio:

$$b / 1 = {x}_{c min} / {x}_{Fe max}$$

Sphericity SPHT is calculated from the projection area A of the particle being analysed relative to the area of a circle having the same circumference P of the projected particle according to the following formula (more detailed information may be found for example in “Operating Instructions/Manual Particle Size Analysis System CAMSIZER®”, Retsch Technology GmbH, 42781 Haan; Doc. No. CAMSIZER V0115):

$$SPHT = 4 π A / {P}^{2}$$

The index SPHT corresponds to the square of the circularity C according to ISO 9276-6.

In order not to create an excessive number of pages in the description of the present invention, only the preferred embodiments of the individual features are specified hereinbelow. However, the expert reader should explicitly understand this type of disclosure as meaning that every combination of different preference levels is also explicitly disclosed and explicitly desired.

### Plastics Composition (S)

Suitable plastics include all known classical non-silicone-based elastomeric, thermoplastic or thermosetting polymers and copolymers, such as are described in the prior art, for example in Ullmann, vol. 15, p. 457 ff., Verlag VCH.

Suitable thermoplastic polymers are for example polyolefins, for example polyethylene, polypropylene and polystyrene, polyamides, polyimides, polyesters, polyether esters, polyphenylene ethers, polyacetal, polybutylene terephthalate (PBT), polyethylene terephthalate (PET), polymethyl methacrylate, polyvinyl acetal, polycarbonate, polyacrylate, acrylonitrile-butadiene-styrene (ABS), acrylonitrile-styrene-acrylic ester (ASA), styrene-acrylonitrile (SAN), polycarbonate, polyurea, silane-modified polymers (SMPs), polyurethane, polyether sulfones and polyether ketones and copolymers, mixtures and/or polymer blends thereof, for example PC/ABS, MABS.

Suitable thermosetting polymers are for example phenol resin, thermosetting polyurethane, melamine resins, polyester and epoxy resin, acrylic resin.

Suitable elastomers are for example styrene-butadiene rubber (SBR), nitrile rubber (NBR), chloroprene rubber (CR), fluoropolymer rubber (FKM), butadiene rubber (BR), ethylene-propylene-diene rubber (EPDM), silane-modified polymers (SMPs), polyacrylate elastomer, polyurethane.

Mixtures and copolymers of different polymers are also suitable. The term copolymers comprises variants in which prepolymers or monomers of different chemical structures are polymerized with one another. Suitable examples include ethylene-vinyl acetate copolymer (EVA, VAE). Mixtures of more than two substances, also referred to as terpolymers, are also suitable.

Preferred plastics are selected from polyurethane, polyacrylate, epoxy resins, acrylic resins, polyurea, ethylene-vinyl acetate copolymer (EVA, VAE), silane-modified polymers (SMPs), polyethylene, polypropylene and polystyrene. Particularly preferred plastics are polyurethane, polyacrylate, epoxy resins, acrylic resins and silane-modified polymers (SMPs).

The inventive plastics composition (S) may contain further additions and additives. These are known to those skilled in the art and described in the prior art. Examples of further additives are processing aids, stabilizers, flame retardants, fungicides, fragrances, active or inactive fillers, plasticizers, fire retardancy-imparting agents, agents for influencing electrical properties, dispersing agents, solvents, pigments, impact modifiers, heat stabilizers, dyes, nesosilicates, adhesion promoters.

The inventive addition-crosslinking plastics composition (S) may contain alkyltrialkoxysiloxanes (F) as further additions to reduce its viscosity. If they are present, they are preferably present in amounts of 0.1-8% by weight, preferably 0.2-6% by weight, based on the total mass of plastics composition (S), wherein the alkyl group is a saturated or unsaturated, linear or branched, alkyl group having 2 to 20 carbon atoms, preferably having 8-18 carbon atoms, and the alkoxy groups may comprise 1 to 5 carbon atoms. Examples of the alkoxy groups include methoxy groups, ethoxy groups, propoxy groups and butoxy groups, wherein methoxy groups and ethoxy groups are particularly preferred. Especially preferred alkyltrialkoxysiloxanes (F) are n-octyltrimethoxysilane, n-dodecyltrimethoxysilane, n-hexadecyltrimethoxysilan and n-Octadecyltrimethoxysilane.

### Thermally Conductive Filler (Z)

The inventive thermally conductive plastic composition (Y) contains at least one thermally conductive filler (Z) having a thermal conductivity of at least 5 W/mK, with the proviso that the inventive thermally conductive plastics compositions (Y) contain at least 20% by volume of metallic silicon particles also fulfilling at least the further further specific features a) to c) as thermally conductive fillers (Z) and the total amount of thermally conductive fillers (Z) is at least 50% by volume.
a) the average diameter x50 of these inventive metallic silicon particles (Z) is in the range 30-200 μm, by preference in the range 35-180 μm, preferably in the range 40-160 μm.
b) the inventive metallic silicon particles (Z) are predominantly rounded and are preferably produced by a melting process. The predominantly rounded shape of the particles according to the invention is characterized in that the width/length ratio (aspect ratio w/l) is at least 0.76, by preference at least 0.77, preferably at least 0.78, in particular at least 0.79.

The inventive silicon particles (Z) have a sphericity SPHT of at least 0.77, preferably at least 0.78, especially preferably of at least 0.79.

In an especially preferred embodiment the inventive silicon particles (Z) have an aspect ratio of at least 0.76 and simultaneously a sphericity SPHT of at least 0.77, preferably at least 0.78, especially preferably of at least 0.79.
c) the distribution width of the particle size (SPAN) is defined as SPAN = (x90−x10)/x50.The SPAN of the inventive metallic silicon particles (Z) is at least 0.28, preferably at least 0.30, particularly preferably at least 0.35, especially preferably at least 0.38. In a preferred embodiment the SPAN is between 0.40 and 2.5, preferably between 0.41 and 2.2, in particular between 0.5 and 2.0.

It is immaterial whether a single fraction of silicon particles (Z) whose SPAN is in the inventive range is used or whether two or more fractions of silicon particles are mixed to achieve the inventive particle size distribution width according to feature c) of the inventive silicon particles (Z). If two or more fractions of silicon particles are mixed this may be effected prior to the mixing with one or more components of the inventive composition or the fractions of silicon particles may also be separately mixed with one or more components of the inventive composition. The sequence of addition is immaterial.

It is preferable when not more than four fractions of silicon particles are mixed to achieve the inventive distribution width, preferably not more than three fractions of silicon particles and mixed to achieve the inventive distribution width, particularly preferably not more than two fractions of inventive silicon particles are employed to achieve the inventive distribution width, especially preferably only a single inventive silicon powder is employed.

In a preferred embodiment the silicon particles (Z) also fulfill the following feature d):
d) The inventive silicon particles (Z) preferably contain not more than 1.5% by weight of silicon particles smaller than 2 μm, preferably not more than 1% by weight, particularly preferably not more than 0.5% by weight, in each case based on the total amount of silicon particles (Z). Especially preferred silicon particles (Z) are substantially free from particle fractions smaller than 2 μm. The term “substantially free from” is to be understood as meaning that the presence of such particles is tolerated in the context of an “impurity” of the inventive particles (Z) and does not disrupt their inventive effect.

The inventive silicon particles (Z) preferably contain less than 20% by weight, preferably less than 15% by weight, particularly preferably less than 10% by weight, of a particle fraction having a diameter of less than or equal to 20 μm, in each case based on the total amount of silicon particles.

The inventive silicon particles (Z) preferably contain less than 15% by weight, preferably less than 10% by weight, particularly preferably less than 5% by weight, of a particle fraction having a diameter of less than or equal to 10 μm, in each case based on the total amount of silicon particles.

In an especially preferred embodiment no intentional addition of silicon particles having an average diameter of less than or equal to 10 μm is carried out. It is preferable when no silicon particles having a particle size less than or equal to 15 μm is added. It is especially preferable when no intentional addition of silicon particles having an average diameter of less than or equal to 20 μm is carried out.

Very fine silicon particles or milled silicon particles, such as are employed in the prior art, also have the disadvantage that such particles have a relatively large surface area and bind a great deal of polymer. This very markedly increases the viscosity of the plastics composition, so that only mixtures having relatively low filler contents and thus low thermal conductivities are obtainable. At higher filler contents the composition becomes very stiff and can no longer be dispensed using classical processes, for example a dispenser. Plastics compositions containing ground silicon particles have also proven to be relatively flammable. The inventive, relatively large and substantially rounded silicon particles simultaneously fulfilling the features a)-c) have the advantage that they make it possible to obtain inventive plastics compositions having a higher filler content and a higher thermal conductivity which exhibit good processability and relatively low flammability.

Metallic silicon has several very advantageous properties for use as thermally conductive filler (Z). For example the exceptionally high thermal conductivity of silicon particles (Z) improves the thermal conductivity of the thermally conductive plastics compositions (Y) produced therefrom. The low density of the silicon particles (Z) reduces the weight of the composition and the components produced therefrom and helps to save costs. The low electrical conductivity makes it possible to produce electrically insulating components and improves dielectric strength. The low Mohs hardness of the silicon particles (Z) reduces abrasion during processing. A person skilled in the art is aware that the recited advantages are wholly or partially lost with decreasing purity of the silicon. The purity of the inventive silicon particles (Z) and thus the content of silicon is at least 80%, preferably at least 90%, particularly preferably at least 95%.

A person skilled in the art is further aware that under certain conditions metallic silicon particles are flammable and their dusts pose an explosion hazard. A person skilled in the art is also aware that the risk of dust formation, the flammability and the explosion hazard of metal powders markedly increases with decreasing particle size. It is for this reason that very small silicon particles below 30 μm are unsuitable for many applications. Due to their low minimum ignition energy such particles are hazardous to handle and necessitate complex and costly safety measures in the course of industrial processing. It has further been found that compositions containing very small silicon particles below 30 μm are relatively highly flammable.

Larger silicon particles having an average particle size above 30 μm exhibit a relatively high minimum ignition energy and are therefore simpler and safer to process in industrial processes. Nevertheless, compositions containing noninventive milled, sharp-edged silicon particles larger than 30 μm have proven relatively highly flammable.

Silicon particles having an average particle size of above 200 μm are unsuitable for many applications of thermally conductive plastics compositions since such large particle size silicon particles often do not fit into the small gaps intended to be filled with gap filler for example. It has further been found that even such large particle size silicon particles exhibit relatively high flammability.

The use of spherical fillers to improve the flowability and processability of filled polymers is well known in the prior art. However, the prior art includes only very few documents in which spherical silicon particles are used in thermally conductive plastics. The disclosed compositions contain exclusively very small spherical silicon particles having an average particle size of less than 30 μm, whose disadvantages are described above.

It has now been found that, entirely surprisingly, the inventive thermally conductive plastics compositions (Y) are thermally conductive while simultaneously exhibiting low flammability when they contain inventive metallic silicon particles simultaneously fulfilling the features a) to c) in the required minimum amounts.

The inventive plastics composition (Y) contains at least 20% by volume of such metallic silicon particles (Z), by preference at least 25% by volume, preferably at least 30% by volume, especially preferably at least 35% by volume. If the plastics composition (Y) contains smaller amounts of metallic silicon particles (Z) the desired advantageous effects of the metallic silicon, for example the low density and the high thermal conductivity, are no longer sufficiently apparent.

The prior art discloses various methods for producing a finely divided metal particles having a rounded shape. The inventive silicon particles (Z) are preferably produced from a molten state, as a result of which they exhibit a relatively smooth surface and are substantially free from fracture sites, sharp edges and sharp corners. This distinguishes them from conventional ground particles that have been brought into their final shape by crushing, grinding or milling for example. It is immaterial whether the particles are comminuted in a cold state in the first process step, for example by milling, and subsequently brought into the molten form by heating above their melting point, for example by heat treatment in a hot zone, for example using a plasma, or whether a silicon melt is initially produced and subsequently comminuted, for example by atomizing. It is preferable when the inventive silicon particles are brought into their inventive solid particle shape by spraying or atomizing of a silicon melt and subsequent cooling.

Suitable processes for producing the inventive silicon particles (Z) are known to those skilled in the art and described for example in Chapter 2.2 of “Pulvermetallurgie: Technologien und Werkstoffe, Schatt, Werner, Wieters, Klaus-Peter, Kieback, Bernd, S. 5-48, ISBN 978-3-540-681112-0, E-Book: https://doi.org/10.1007/978-3-540-68112-0_2”. Preferred processes for producing the inventive silicon particles (Z) are inert gas spraying, also known as gas atomization, pressurized water spraying, also known as liquid atomization or water atomization processes, or melt spinning process is, also known as centrifugal atomization or rotational atomization.

The described processes make it possible to produce metallic silicon particles in very different particle size ranges, in particular in an average particle size range of a few micrometers to a few millimeters. In addition, the metallic silicon particles may be produced in very different particle shapes, for example “spattered”, i.e. very irregular, ellipsoid, or spherical, and with very different particle size distribution widths.

It has now been found that, entirely surprisingly, exclusively silicon particles which are predominantly rounded and simultaneously fulfill the inventive features a) to c) exhibit inventive advantageous properties, in particular a relatively low flammability.

The production process of the inventive metallic silicon particles (Z) is by preference to be performed such that the particles are obtained in their inventive predominantly rounded shape and thus fulfill the features a)-c) and are substantially free from sharp-edged or pointed particles. The production process of the inventive metallic silicon particles (Z) is preferably to be performed such that the particles are obtained in their inventive predominantly rounded shape and thus fulfill the features a)-c) and are substantially free from spattered, nodular, sharp-edged or pointed particles. The solidified particles may be separated by size by commonly used processes in the subsequent process step, for example by classifying, by sieving or by sifting. These processes make it possible to separate agglomerates and bonded particles but substantially no particles are destroyed. The term “substantially rounded/substantially free from” is to be understood as meaning that the presence of such particles is tolerated in the context of an “impurity” of the inventive particles (Z) and does not disrupt their inventive effect.

In addition to these metallic silicon particles (Z) the inventive plastics composition (Y) may contain further thermally conductive fillers (Z) having a thermal conductivity of greater than 5 W/mK. Examples of such further thermally conductive fillers (Z) are magnesium oxide, metallic aluminum powder, metallic silver powder, zinc oxide, boron nitride, silicon carbide, aluminum nitride, aluminum hydroxide, aluminum oxide, graphite etc. Preferred further fillers are aluminum powder, magnesium oxide, aluminum hydroxide, zinc oxide and aluminum oxide. Particularly preferred further thermally conductive fillers (Z) are zinc oxide, aluminum hydroxide and aluminum oxide. The shape of the further filler is not limited in principle. The particles may be spherical, ellipsoidal, acicular, tubular, flake-shaped, fiber-shaped or irregularly shaped for example. They are preferably spherical, ellipsoidal or irregularly shaped. The average diameter of the further thermally conductive fillers (Z) is by preference in the range 0.01-200 μm, preferably in the range 0.1-150 μm, particularly preferably in the range 0.2-120 μm, in particular in the range 0.4-80 μm.

Fillers of very high density are disadvantageous to employ in airplanes and electric vehicles for example since they very markedly increase the weight of the components. It is preferable when the further thermally conductive fillers (Z) have a density of not more than 6.0 g/cm³, preferably not more than 4.5 g/cm³, particularly preferably not more than 3.0 g/cm³.

It is preferable when the inventive plastic composition (Y) contains not more than 24% by weight, preferably not more than 20% by weight, particularly preferably not more than 16% by weight, especially preferably not more than 12% by weight, of a further thermally conductive filler (Z) having a density of greater than 5.0 g/cm³.

In many applications an electrical conductivity of the thermally conductive composition is undesired since this may lead to short circuits for example. The inventive plastics composition (Y) preferably contains exclusively thermally conductive fillers (Z) whose specific resistance is at least 1 Ω·mm²/m.

Preferred inventive thermally conductive plastics compositions (Y) contain the inventive metallic silicon particles as the sole thermally conductive filler (Z) or in combination with up to three further thermally conductive fillers (Z). Impurities of up to 5% are not considered as constituting a further filler (Z).

The total amount of thermally conductive fillers (Z) in the inventive thermally conductive plastic composition (Y) is 50-95% by volume, by preference 60-90% by volume, preferably 65-88% by volume. If the plastics composition (Y) contains smaller amounts of thermally conductive filler (Z) the thermal conductivity is insufficient and if the plastics composition (Y) contains larger amounts of thermally conductive filler (Z) the composition (Y) becomes difficult to process since it becomes highly viscous or even brittle.

The inventive thermally conductive plastics compositions (Y) exhibit a thermal conductivity of at least 0.6 W/mK, by preference at least 0.8 W/mK, preferably at least 1.2 W/mK, in particular at least 1.5 W/mK.

The viscosity of the inventive thermally conductive plastics compositions (Y) may be varied over a very wide range and be adapted to the requirements of the application. Adjustment of the viscosity of the inventive thermally conductive plastics compositions (Y) is preferably carried out via the content of thermally conductive filler (Z) and/or the composition of the plastic composition (S) according to the customary methods from the prior art. These are known to those skilled in the art. Adjustment of the viscosity is preferably effected via the selection of a combination of the components (S) and (Z) and the optional addition of additives.

The density of the inventive thermally conductive classics compositions (Y) is less than 4.5 g/cm³, by preference less than 4.0 g/cm³, preferably less than 3.5 g/cm³, in particular less than 3.3 g/cm³.

The invention further provides a process for producing the inventive thermally conductive plastics compositions (Y) by mixing the individual components.

The incorporation of the inventive thermally conductive fillers (Z) may be carried out for example by compounding, via a masterbatch, via pastes or via direct addition. The inventive compositions (S) may optionally be admixed with further additives during incorporation of the inventive thermally conductive filler (Z). The components may in principle be added in any desired sequence.

The components may be mixed according to the customary continuous and batchwise processes of the prior art. Suitable mixing apparatuses include all known apparatuses. Examples thereof include uniaxial or biaxial continuous mixers, double rollers, Ross mixers, Hobart mixers, dental mixers, extruders, planetary mixers, kneaders and Henschel mixers or similar mixers. The preferred processing method generally depends on the employed polymer material.

The invention further provides for the use of the thermally conductive filler (Z) for improving the thermal conductivity of plastics compositions (S) selected from non-silicone-based elastomeric, thermoplastic and thermosetting polymers and copolymers.

The invention further provides the plastic products obtained by filling or applying and subsequent crosslinking or curing. The cured plastics products (for example a thermally conductive element) exhibit excellent thermal conductivity and precise layer thicknesses.

The hardness of the inventive thermally conductive plastics compositions (Y) may be varied over a very wide range and be adapted to the requirements of the application. Thus relatively soft and flexible products are preferred for use in gap filler applications for example while relatively hard and rigid products are preferred for use in thermally conductive adhesive applications for example. The adjustment of the hardness of the inventive thermally conductive plastics compositions (Y) generally depends on the employed polymer material and is carried out according to the customary methods from the prior art. These are known to those skilled in the art.

The inventive plastics products exhibit a thermal conductivity of at least 0.6 W/mK, by preference at least 0.8 W/mK, preferably at least 1.2 W/mK, in particular at least 1.5 W/mK.

The present invention further provides for the use of the thermally conductive plastics compositions (Y) as thermally conductive paste, gap filler (=thermally conductive element), a thermally conductive pad, thermally conductive adhesives and potting compounds for dissipating heat from heat generators or heat dissipators in electronic apparatuses.

The thermally conductive plastics composition (Y) is applied to heat generators or heat dissipators or said generators or dissipators are coated therewith or the already crosslinked or cured thermally conductive plastics composition (Y) is introduced between heat generators or heat dissipators in the form of a thermally conductive pad for example.

Suitable heat generators are found for example in electronic apparatuses of electricity supplies and in electronic devices, for example supply transistors, power modules, transistors, thermocouples and temperature sensors; heat generating electronic parts, for example integrated circuit parts such as CPUs and batteries. In the automotive industry heat generators are found in particular in the vicinity of lithium-ion batteries, charging infrastructure and control devices and sensors. Suitable heat dissipators comprise heat dissipating components such as heat distributors and heat sinks and cooling fins. If the thermally conductive plastics composition (Y) is introduced between a heat generator and a heat dissipator the heat may be efficiently conducted from the heat generator to the heat dissipator. This achieves effective cooling of the heat generator. The inventive thermally conductive plastics compositions (Y) are especially suitable for use as gap fillers for lithium-ion batteries of electric vehicles and as a potting compound for electronic components of electric vehicles for example.

### Methods of Measurement

### Measurement of Thermal Conductivity Lambda

Thermal conductivity is determined according to ASTM D5470-12 using a TIM Tester (Steinbeis Transferzentrum Wärmemanagement in der Elektronik, Lindenstr. 13/1, 72141 Walddorfhäslach, Germany). The thermal resistance of the sample arranged between 2 test cylinders is determined via a constant heat flow. The effective thermal conductivity of the sample is calculated over the layer thickness of the sample.

For measurement, the sample is applied using a stencil and the measuring cylinders are manually brought together to a thickness of 1.9-2.0 mm before removing excess material. Measurement of thermal conductivity is carried out at a constant gap of 1.8-1.6-1.4-1.2-1.0 mm. Evaluation is via an integrated reporting unit. After a plausibility test (straight-line coefficient of determination>0.998) the thermal conductivity Lambda is reported as the effective thermal conductivity W/(m*K).

### Particle Size and Particle Shape Analysis

Analysis of particle size (average diameter x50), particle size distribution (parameter: standard deviation Sigma and distribution width SPAN) and particle shape (parameter: aspect ratio w/l and sphericity SPHT) was carried out with a Camsizer X2 from Retsch Technology (measurement principle: dynamic image analysis) according to ISO 13322-2 and ISO 9276-6 (analysis type: dry measurement of powders and granulates; measurement range: 0.8 μm-30 mm; compressed air dispersion with “X-Jet”; dispersion pressure=0.3 bar). Evaluations were carried out on a volume basis according to the model x_{c min}.

The examples that follow describe how the present invention may be performed in principle but without this limiting said invention to what is disclosed therein.

In the examples below all reported quantities in parts and percentages are based on weight unless otherwise stated. Unless otherwise stated the examples which follow were performed at ambient pressure, i.e. at about 1000 hPa, and at room temperature, i.e. about 20° C., or a temperature established upon combining the reactants at room temperature without additional heating or cooling.

### Examples

### Overview of Employed Inventive and Noninventive Silicon Powders and Silicon Powder Mixtures

Table 1 summarizes the properties of the inventive and noninventive silicon powders used in the examples.

The inventive example 1 uses an inventive silicon powder which was obtained by inert gas atomization and is thus predominantly rounded and additionally has a relatively broad, inventive particle size distribution.

The noninventive comparative example V1 employs a noninventive silicon powder which was obtained by inert gas atomization and is thus predominantly rounded but has a relatively narrow, noninventive particle size distribution and does not fulfill the inventive feature c).

The noninventive comparative example V2 employs a noninventive silicon powder which has a relatively broad, inventive particle size distribution but was obtained by a milling process and is thus substantially angular and sharp-edged and does not fulfill the inventive feature b).

### Abbreviations

Ex. Example
C Comparative example
PS Particle shape
r Predominantly rounded
a Angular
I Inventive
NI Noninventive
n.d. Not determined

TABLE 1
Overview of employed silicon powder

| | | ×50 | | | | | | |
|---|---|---|---|---|---|---|---|---|
| | | (μm) | | SPAN | | | | |
| | ×10 | Feature | ×90 | Feature | | PS | w/l | |
| Ex. | (μm) | a) | (μm) | c) | SPHT | Feature b) | | Remark |
| 1* | 23.4 | 58.9 | 123.3 | 1.69 | 0.82 | r | 0.85 | E |
| C1 | 72.6 | 82.1 | 92.2 | 0.24 | 0.89 | r | 0.83 | NE |
| C2 | 10.8 | 36.9 | 84.9 | 2.01 | 0.76 | e | 0.67 | NI |

*The content of silicon particles <2 μm was 0.0% by weight within the range of measurement accuracy.

### General Procedure 1 (GP1) for Producing a 1-Component, Cured, Thermally Conductive Silicon Powder-Containing Shaped Plastics Article (Inventive Example 2 and Noninventive Examples C3 to C5)

### Step 1: Production of a 1-Component, Curable, Thermally Conductive Silicon Powder-Containing Plastics Composition.

The 1-component, curable, thermally conductive plastics composition and the silicon powder were mixed for 25 seconds at a speed of 2350 rpm using a SpeedMixer DAC 400 FVZ (Hauschild & Co KG, Waterkamp 1, 59075 Hamm, Germany) The silicon particle-containing plastics composition was stirred with a spatula, ensuring that silicon powder residues from the vessel edge were stirred in. The mixture was subsequently homogenized for a further 25 seconds at 2350 rpm using the SpeedMixer and cooled to room temperature. The input materials and quantity fractions are reported in table 2.

A pasty mass was obtained.

### Step 2: Production of a Cured, Thermally Conductive Silicon Powder-Containing Shaped Plastics Article

The curing of the silicon powder-containing plastics composition from step 1 is carried out according to the specific curing conditions of the employed plastics composition according to manufacturer specifications. The employed conditions are reported in table 2.

### General Procedure 2 (GP2) for Producing a Thermally Conductive, Silicon Powder-Containing, 2-Component Plastics Composition (Inventive Example 3 and Noninventive Dxamples C6 to C8)

### Step 1: Production of a 2-Component, Thermally Conductive Silicon Powder-Containing Plastics Composition.

The A-component and the B-component of the 2-component plastics composition were each separately mixed with the silicon powder for 25 seconds at a speed of 2350 rpm using a SpeedMixer DAC 400 FVZ (Hauschild & Co KG, Waterkamp 1, 59075 Hamm, Germany). The silicon particle-containing plastics compositions were each stirred with a spatula, ensuring that silicon powder residues from the vessel edge were stirred in. The mixtures were each subsequently homogenized for a further 25 seconds at 2350 rpm using the SpeedMixer and cooled to room temperature. The input materials and quantity fractions are reported in table 3.

Respective pasty masses were obtained.

### Step 2: Production of a Crosslinked, Thermally Conductive Silicon Powder-Containing Shaped Plastics Article

The silicon powder-containing A-and B-components produced in step 1 were combined and homogenized for 25 seconds and 2350 rpm using the SpeedMixer. The curing of the 2-component silicon powder-containing plastics composition is carried out according to the specific curing conditions of the employed plastics composition according to manufacturer specifications. The employed conditions are reported in table 3.

### Example 4 Flammability Test

The flammability test is carried out in a simplified test based on UL 94 HB.

The inventive plastics compositions according to examples 2 and 3 and the noninventive plastics compositions according to the comparative examples C3 to C6 are applied in a 2 mm-thick layer to an aluminum plate of 150 mm in length, 10 mm in width and 2 mm in thickness and cured according to the specifications in table 2 or table 3. The plate is secured in the vertical position by its right-hand long side such that the aluminum carrier faces downwards and the knife-coated sample faces upwards. The burner is adjusted such that a blue flame of 325 mm in length is formed. The flame is pointed at the test specimen horizontally such that the tip of the blue flame points at the front face of the test piece 20 mm from the left-hand end of the test piece. The flame is removed after 30 seconds of exposure.

Testing and evaluation of flammability: During application of the flame the flame pattern and the height of the glowing flame are determined. The afterburn time (total time composed of afterburn and afterglow) of the test piece is noted.

TABLE 2
Composition and flammability silicon powder-
containing 1-component plastics compositions

| | | Ex. 2 | C3 | C4 | C5 |
|---|---|---|---|---|---|
| | | % by wt. | % by wt. | % by wt. | % by wt. |
| Product | | (% by vol.) | (% by vol.) | (% by vol.) | (% by vol.) |
| Plastics | Soudal | 20 (35.4) | 20 (35.4) | 30 (48.4) | 20 (35.4) |
| composition | Transpacryl | | | | |
| | transparent | | | | |
| | acrylic | | | | |
| | (Basis: 1-K | | | | |
| | acrylate | | | | |
| | dispersion) | | | | |
| Silicon | Ex. 1 | 80 (64.6) | | | |
| powder | C2 | | 80 (64.6) | 70 (51.6) | |
| | C1 | | | | 80 (64.6) |
| Thermal | W/mK | 2.31 | n.d. | n.d. | n.d. |
| conductivity | | | | | |
| Density | calculated | 1.87 | 1.87 | 1.71 | 1.87 |
| Curing | method | A | — | A | A |
| Flame | Appearance | moderate | n.d. | intensive | intensive |
| pattern | | combustion | | combustion, | combustion |
| | | | | sooty | |
| Flame | cm | 8 | n.d. | 12 | 12 |
| height | | | | | |
| Afterburn | Seconds | 10 | n.d. | 14 | 15 |
| time | | | | | |

A: The sample is cured at room temperature for 1 day.

The noninventive comparative test C3 containing 64.6% by volume of the noninventive. ground silicon particles according to comparative example C2, which especially do not fulfill the feature b), resulted in a very high-viscosity plastics composition which was unable to be applied in a uniform layer and tested.

TABLE 3
Composition and flammability silicon powder-
containing 2-component plastics compositions

| | | Ex. 3 | C6 | C7 | C8 |
|---|---|---|---|---|---|
| | | % by wt. | % by wt. | % by wt. | % by wt. |
| product | | (% by vol.) | (% by vol.) | (% by vol.) | (% by vol.) |
| Plastics | Sika Chemie | 20 (26.6) | 20 (26.6) | 30 (38.3) | 20 (26.6) |
| composition | Sikafloor 390 | | | | |
| | epoxy resin | | | | |
| Silicon powder | Ex. 1 | 80 (73.4) | | | |
| | C2 | | 80 (73.4) | 70 (61.7) | |
| | C1 | | | | 80 (73.4) |
| Thermal | W/mK | 1.82 | n.d. | n.d. | n.d. |
| conductivity | | | | | |
| Density before | calculated | 2.13 | 2.13 | 2.04 | 2.13 |
| curing | | | | | |
| Curing | method | A | — | A | A |
| Flame pattern | Appearance | Weak | n.d. | intensive | intensive |
| | | combustion | | combustion, | combustion |
| | | | | sooty | |
| Flame height | cm | 3 | n.d. | 13 | 10 |
| Afterburn time | Seconds | 1 | n.d. | 10 | 12 |

A: The sample is cured at room temperature for 1 day.

The noninventive comparative test C6 containing 73.4% by volume of the noninventive, ground silicon particles according to comparative example C2, which especially do not fulfill the feature b), resulted in a very high-viscosity plastics composition which was unable to be applied in a uniform layer and tested.

It is surprisingly apparent that the inventive plastic compositions according to examples 2 and 3 which simultaneously fulfill the features a) to c) exhibit a relatively low flammability.

Example 5 Production of a thermally conductive plastics composition containing an in-situ mixture of silicon powders (inventive).

An inventive thermally conductive plastics composition was produced according to the general procedure GP1, wherein employed as the plastics composition were 46.0 g of Soudal

Transpacryl transparent acrylic and added separately as silicon powder and mixed for in-situ formation of an inventive silicon powder mixture were: 18.4 g of a noninventive silicon powder having an x50 of 68.6 μm, a SPAN of 0.20, a w/l of 0.85 and an SPHT of 0.84, 36.8 g of the noninventive silicon powder from comparative example C2, 73.6 g of a noninventive silicon powder having an x50 of 105.4 um, a SPAN of 0.24, a b/l of 0.83 and an SPHT of 0.92, 36.8 g of a noninventive silicon powder having an x50 of 133.8 μm, a SPAN of 0.25, a b/l of 0.82 and an SPHT of 0.94 and 18.4 g of a noninventive silicon powder having an x50 of 162.1 μm, a SPAN of 0.22, a b/l of 0.82 and an SPHT of 0.94.

This afforded an inventive plastics composition having a content of inventive silicon particles of 64.6% by volume. The inventive pasty mass has a good processability. The flammability test according to example 4 resulted in a moderate flame pattern, a flame height of 9 cm and an afterburn time of 10 seconds and thus exhibits a markedly weaker flammability than the comparative examples C3 to C5 which employ the same plastics composition as a basis.

1-13. (canceled)

14. Thermally conductive plastics composition (Y), comprising:
5-50% by volume of a non-silicone-based plastics composition (S) and 50-95% by volume of at least one thermally conductive filler (Z) having a thermal conductivity of at least 5 W/mK;
wherein the thermally conductive plastics composition (Y) has a thermal conductivity of at least 0.6 W/mK; and
wherein at least 20% by volume of metallic silicon particles fulfilling the following features are present as thermally conductive fillers (Z):
a) their average diameter x50 is in the range 30-200 μm;
b) they are predominantly rounded and characterized in that the width/length ratio (aspect ratio w/l) is at least 0.76; and
c) their distribution width SPAN ((x90−x10)/x50) is at least 0.28.

15. The thermally conductive plastics of claim 14, wherein the plastics composition (S) is selected from non-silicone-based elastomeric, thermoplastic and thermosetting polymers and copolymers.

16. The thermally conductive plastics of claim 14,
wherein the plastics composition (S) is selected from the group of thermoplastic polymers: polyethylene, polypropylene and polystyrene, polyamides, polyimides, polyesters, polyether esters, polyphenylene ethers, polyacetal, polybutylene terephthalate (PBT), polyethylene terephthalate (PET), polymethyl methacrylate, polyvinyl acetal, polycarbonate, polyacrylate, acrylonitrile-butadiene-styrene (ABS), acrylonitrile-styrene-acrylic ester (ASA), styrene-acrylonitrile (SAN), polycarbonate, polyurea, silane-modified polymers (SMPs), polyurethane, polyether sulfones and polyether ketones and copolymers, mixtures and/or polymer blends thereof; or
wherein the plastics composition (S) is selected from the group of thermosetting polymers: phenol resin, thermosetting polyurethane, melamine resin, polyester and epoxy resin, acrylic resin;
wherein the plastics composition (S) is selected from the group of elastomers: styrene-butadiene rubber (SBR), nitrile rubber (NBR), chloroprene rubber (CR), fluoropolymer rubber (FKM), butadiene rubber (BR), ethylene-propylene-diene rubber (EPDM), silane-modified polymers (SMPs), polyacrylate elastomer, polyurethane; or
wherein the plastics composition (S) is selected from mixtures thereof and from copolymers where prepolymers or monomers of the abovementioned polymers are polymerized with one another.

17. The thermally conductive plastics of claim 14, wherein the plastics composition (S) is selected from polyurethanes, polyacrylates, epoxy resins, acrylic resins, polyurea, ethylene-vinyl acetate copolymer (EVA, VAE), silane-modified polymers (SMPs), polyethylene, polypropylene and polystyrene and mixtures and copolymers thereof.

18. The thermally conductive plastics of claim 14, wherein the plastics composition (S) is selected from polyurethane, polyacrylate, epoxy resins, acrylic resins and silane-modified polymers (SMPs) and mixtures and copolymers thereof.

19. The thermally conductive plastics of claim 14, wherein the plastics composition (S) contains at least 25% by volume of metallic silicon particles as thermally conductive fillers (Z).

20. The thermally conductive plastics of claim 14, wherein the metallic silicon particles present as thermally conductive fillers (Z) further comprises:
d) they contain not more than 1.5% by weight of silicon particles smaller than 2 μm.

21. The thermally conductive plastics of claim 14, wherein the metallic silicon particles present as thermally conductive fillers (Z) have been produced from a molten state.

22. The thermally conductive plastics of claim 14, wherein the metallic silicon particles present as thermally conductive fillers (Z) have been brought into their solid particle shape from a silicon melt by spraying or atomizing.

23. The thermally conductive plastics of claim 14, wherein the thermally conductive filler (Z) is used for improving the thermal conductivity of the non-silicone-based plastics compositions (S) selected from non-silicone-based elastomeric, thermoplastic and thermosetting polymers and copolymers.

24. The thermally conductive plastics of claim 14, wherein the thermally conductive plastic composition (Y) is used to form a plastic product.

25. The thermally conductive plastics of claim 14, wherein thermally conductive plastics composition (Y) is used as a gap filler (=thermally conductive element), a thermally conductive pad, thermally conductive adhesives and potting compounds for dissipating heat from heat generators or heat dissipators in electronic apparatuses

26. A process for producing a thermally conductive plastic composition (Y), comprising:
providing 5-50% by volume of a non-silicone-based plastics composition (S) and 50-95% by volume of at least one thermally conductive filler (Z) having a thermal conductivity of at least 5 W/mK,
wherein the thermally conductive plastics composition (Y) has a thermal conductivity of at least 0.6 W/mK, and
wherein at least 20% by volume of metallic silicon particles fulfilling the following features are present as thermally conductive fillers (Z):
a) their average diameter x50 is in the range 30-200 μm,
b) they are predominantly rounded and characterized in that the width/length ratio (aspect ratio w/l) is at least 0.76, and
c) their distribution width SPAN ((x90−x10)/x50) is at least 0.28; and
mixing the individual components together.

27. The process of claim 26, filling or applying and subsequently crosslinking or curing the thermally conductive plastics compositions (Y).

28. The process of claim 27, further comprising forming a plastic product.
